(19) United States
(12) Patent Application Publication
(10) Pub. No.: US 2014/0150271 A1
(43) Pub. Date: Jun. 5, 2014

(54) CHAIN SAW

(71) Applicant: Chervon (HK) Limited, Wanchai (HK)

(72) Inventors: Toshinari Yamaoka, Nanjing (CN); Huixing Fu, Nanjing (CN)

(73) Assignee: Chervon (HK) Limited, Wanchai (HK)

(21) Appl. No.: 13/962,345

(22) Filed: Aug. 8, 2013

(30) Foreign Application Priority Data
Dec. 5, 2012 (CN) 201210516756.2

(51) Int. Cl. B27B 17/14

(52) U.S. Cl. CPC B27B 17/14
USPC 30/386

(57) ABSTRACT

A chain saw includes a housing, a cutting chain, a chain wheel, a guide plate cooperating with the chain wheel to support and guide the cutting chain, a cover plate cooperating with the housing, and a chain wheel tensioning mechanism. The chain wheel tensioning mechanism is wholly combined and disposed movably in the housing so that during the assembly procedure, positions and states of parts such as the cutting chain, the guide plate, the tensioning nut, and the chain wheel can be observed and so that the positioning is accurate and the operation is simple and quick. A distance between the guide plate and the chain wheel is adjusted to tension the cutting chain by use of a tensioning handwheel that is connected to a transmission member where the transmission member causes the tensioning nut fixed on the guide plate to move.

### RELATED APPLICATION INFORMATION

This application claims the benefit of CN 201210516756.2, filed on Dec. 5, 2012, the disclosure of which is incorporated herein by reference in its entirety.

### FIELD OF THE INVENTION

The following generally relates to lawn and garden tools and, more particularly, to a chain saw.

### BACKGROUND

A chain saw is a type of lawn and garden tool that is used to cut timber or branches. A chain saw includes a powering device that causes staggered L-shaped blades on a chain to move transversely relative to a cutting surface. Since the chain links in the chain of the chain saw wear in use, the chain becomes longer and loose on a guide plate so that the chain saw cannot operate normally. Therefore, a tensioning force applied on the chain needs to be adjusted frequently to ensure normal operation of the chain saw.

For adjusting the tensioning force applied to the chain two methods are currently known. In one method the tensioning force is adjusted via use of an external tool. In another method the tensioning force is adjusted via use of an adjusting mechanism carried by the chain saw. In the latter case, the tension of the chain is generally adjusted by using a screw rod to cause a tensioning nut to move to adjust the relative positions of the guide plate and the chain.

More particularly, to provide chain tensioning in the latter case a chain saw includes a housing and a cover plate, wherein the housing and the cover plate are fastened together by means of the mating of a bolt fixedly mounted on the housing and a connecting hole provided on the cover plate. In the housing there is mounted a chain wheel for driving the chain and a guide plate which cooperates with the chain wheel to support and guide the chain. The guide plate is provided with a guide plate mounting hole, the cover plate is provided with a chain saw tensioning mechanism wherein the screw rod drives the tensioning nut, a guide plate connecting portion of the tensioning nut is received in the guide plate mounting hole, the screw rod is manually rotated to cause the tensioning nut to move in an axial direction of the screw rod to achieve the tensioning of the chain by adjusting relative positions of the guide plate and the chain.

During assembling, the following conditions need to be satisfied to accurately mount the cover plate on the housing: 1) the bolt fixed on the housing needs to correspond to the connecting hole on the cover plate; and 2) the guide plate mounting hole needs to correspond to the guide plate connecting portion of the tensioning nut. To meet these assembling conditions, in the case that the position of the guide plate is certain, the position of the tensioning nut on the cover plate needs to be manually adjusted. Since the chain saw tensioning device is disposed on the cover plate and the tensioning nut is concealed below the cover plate during assembly its specific position cannot be easily observed thus rendering the assembly processes relatively difficulty. Furthermore, when the screw rod is manually turned to adjust the position of the tensioning nut the traveling distance of the tensioning nut when adjusted by turning the screw rod one turn is short and the operation is uncomfortable because the size of the screw rod is limited.

### SUMMARY

To overcome these and other shortcomings in the prior art, the following describes a chain saw which is convenient to assemble, has a simple locking operation, and is comfortable to use.

To achieve such adjectives, the chain saw includes a housing, a chain, a chain wheel which is driven by a motor, supported in the housing, and which moves the chain, a guide plate for supporting and guiding the chain, and a cover plate cooperating with the housing to hold the guide plate to prevent it from shaking in a vertical direction thereof. The chain saw further includes a chain wheel tensioning mechanism. One end of the guide plate is supported on the housing, and the other end thereof extends out of the housing in a longitudinal direction of the housing. The chain wheel tensioning mechanism is mounted on the housing, and includes a tensioning nut, a transmission member, and a tensioning handwheel. The transmission member includes an input shaft that is mounted on the housing and rotatable relative to the housing, a first transmission element driven by the input shaft, a second transmission element engaging the first transmission element, and an output shaft driven by the second transmission element. The tensioning handwheel is connected with the input shaft of the transmission member. Furthermore, the tensioning handwheel at least partially extends out of the housing. The tensioning nut is fixedly connected with the guide plate and threadedly connected with the output shaft of the transmission member so that the tensioning nut is able to drive the guide plate to move relative to the output shaft. The input shaft is disposed in a plane parallel to the guide plate. An angle between the input shaft and the output shaft of the transmission member is greater than 0° and less than 180°.

The chain wheel tensioning mechanism is disposed in the housing so that during the whole assembly procedure, positions and states of parts such as the chain, the guide plate, the tensioning nut and the chain wheel can be observed, and so that the positioning is accurate, the operation is simple and quick, and time for assembling is saved. A distance between the guide plate and the chain wheel is adjusted to achieve the tensioning of the chain in a way that the tensioning handwheel is connected with the transmission member, the transmission member transmits via bevel gears, and the transmission member brings the tensioning nut fixed on the guide plate to move, and comfort of operation is improved.

### BRIEF DESCRIPTION OF DRAWINGS

FIG. 1 is a schematic view of an exemplary chain saw constructed according to the description which follows;

FIG. 2 is a cross-sectional view of an exemplary chain saw constructed according to the description which follows;

FIG. 3 is a planar view of an exemplary chain wheel tensing mechanism and related components constructed according to the description which follows;

FIG. 4 is a perspective view of the exemplary chain wheel tensing mechanism and related components constructed according to the description which follows;

FIG. 5 is a schematic view of an exemplary chain saw constructed according to the description which follows with a chain, a cover plate and a guide plate not mounted; and

FIG. 6 is a schematic view of an exemplary chain saw constructed according to the description which follows with the cover plate not mounted.

### DETAILED DESCRIPTION OF PREFERRED EMBODIMENTS

An exemplary, preferred chain saw is now is described in detail with reference to the figures.

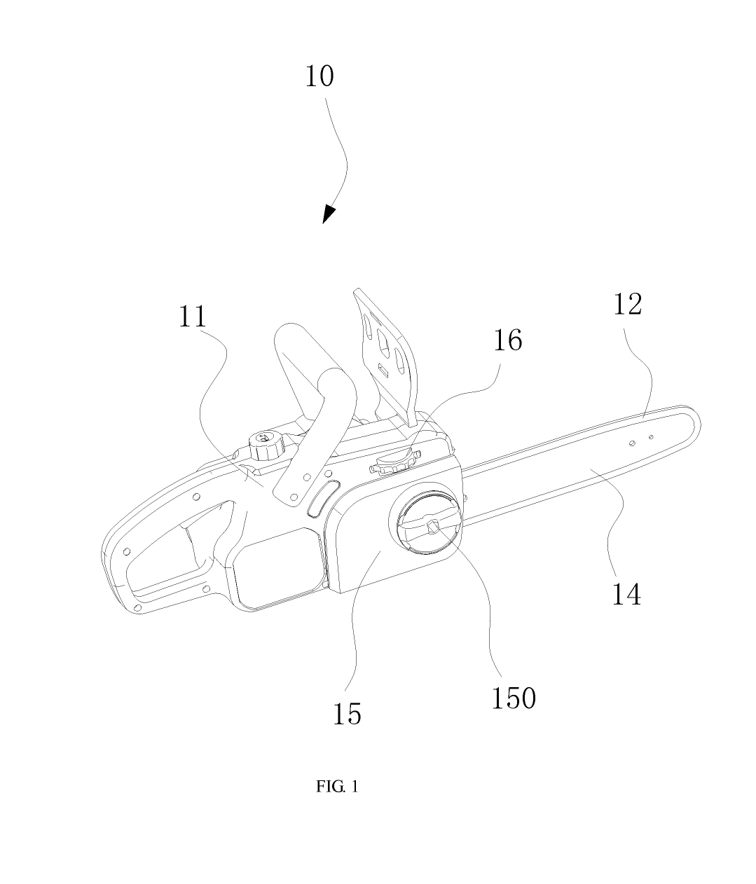

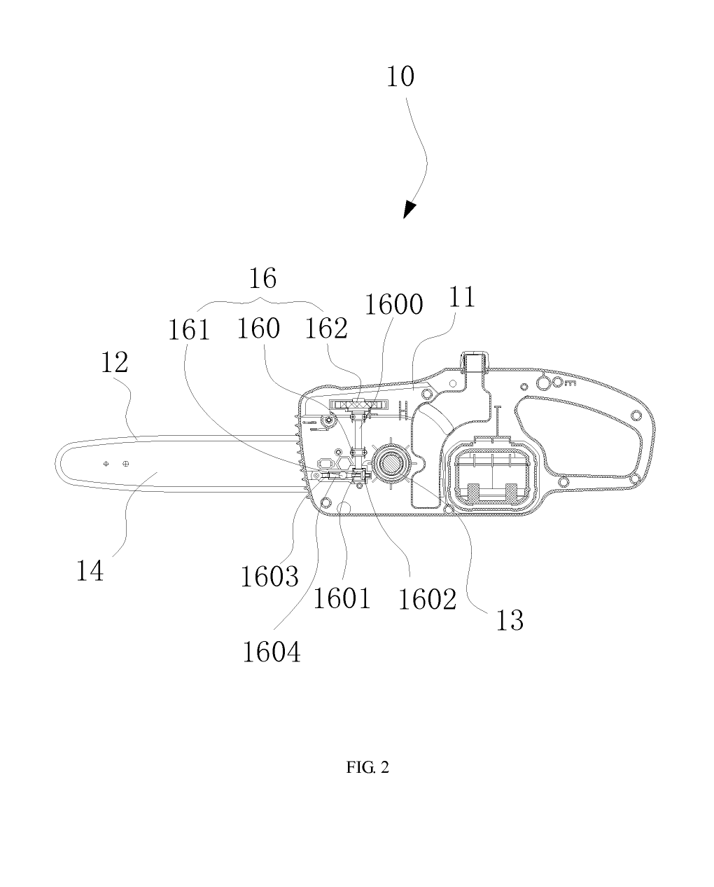

Referring to FIG. 1 and FIG. 2, a chain saw 10 includes a housing 11, a chain 12, a chain wheel 13 supported in the housing 11 and driving the chain 12 to move, a guide plate 14 for supporting and guiding the chain 12, a cover plate 15, and a chain wheel tensioning mechanism 16. The cover plate 15 cooperates with the housing 11 to hold the guide plate 14 to prevent it from shaking in a vertical direction thereof.

The chain wheel 13 is driven by a motor and the chain 12 is hung to wheel teeth of the chain wheel 13. The chain 12 surrounds a periphery of the guide plate 14 and is guided by the guide plate 14 to move cyclically there around. An end of the guide plate 14 is supported on the housing 11, and the other end thereof extends out of the housing 11 in a longitudinal direction of the housing 11. To produce a chain tension, the guide plate 14 is movable relative to the housing 11 in the longitudinal direction so as to tension the chain 12 by adjusting the distance between the guide plate 14 and the chain wheel 13.

To tension the chain 12, the guide plate 14 is fixed at a suitable position of the housing 11 according to wear conditions of the chain 12.

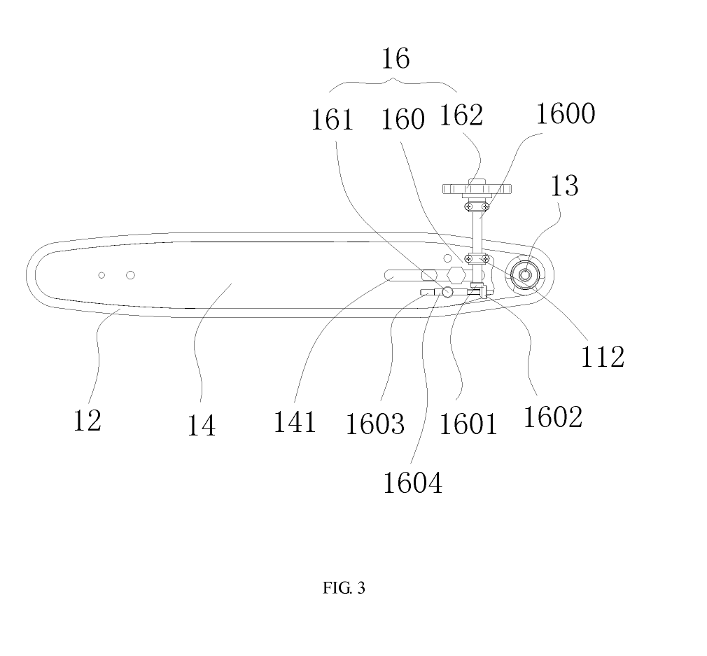

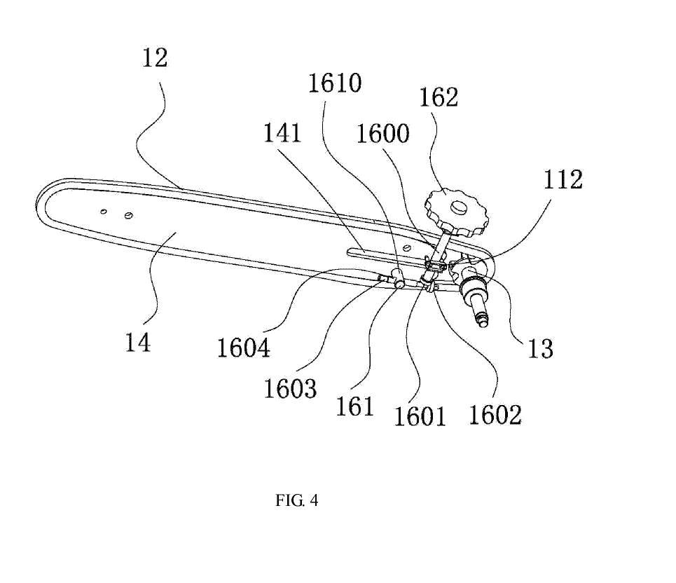

Referring to FIG. 3 and FIG. 4 simultaneously, the chain wheel tensioning mechanism 16 is illustrated as being disposed in the housing 11, and includes a transmission member 160, a tensioning nut 161 and a tensioning handwheel 162.

In the illustrated embodiment, the transmission member 160 includes an input shaft 1600, a first transmission element 1601 unrotatably connected with the input shaft 1600, a second transmission element 1602 engaging the first transmission element 1601, and an output shaft 1603 unrotatably connected with the second transmission element. In the illustrated embodiment, both of the first transmission element 1601 and second transmission element 1602 are bevel gears.

The tensioning handwheel 162 is disposed in a groove 110 formed on the housing 11 and is rotatable about its own axis. The tensioning handwheel 162 at least partially extends out of the groove 110 of the housing 11 so that it may be adjusted manually from outside of the housing 11 in the absence of an individual tool. To facilitate the mounting of the output shaft 1603, a mounting slot 111 for receiving the output shaft 1603 and the second transmission element 1602 is integrally formed on the housing 11, and the second transmission element 1602 is unrotatably sleeved around one end of the output shaft 1603.

The input shaft 1600 is disposed in a plane parallel to the guide plate 14. One end of the input shaft 1600 is connected with the tensioning handwheel 162. A positioning opening 112 is provided in the housing 11 for preventing the input shaft 1600 from deviating. The other end of the input shaft 1600 passes through the positioning opening 112 and then is connected with the first transmission element 1601. The first transmission element 1601 engages with the second transmission element 1602 to transfer driving force of the input shaft 1600 to the second transmission element 1602. Rotational axes of the first transmission element 1601 and the second transmission element 1602 are coplanar and parallel to the guide plate 14. Since the second transmission element 1602 is unrotatably connected with the output shaft 1603, the power of the input shaft 1600 can be transferred by means of cooperation of the first transmission element 1601 and the second transmission element 1602 to the output shaft 1603 and brings the output shaft 1603 to rotate along its axis. In the illustrated embodiment, the input shaft 1600 is perpendicular to the output shaft 1603. It may be appreciated that an angle between the input shaft 1600 and the output shaft 1603 may be adjusted by adjusting a cooperative angle between the first transmission element 1601 and the second transmission element 1602. Therefore, the angle between the input shaft 1600 and the output shaft 1603 is greater than 0° and less than 180°.

A tensioning nut 161 is connected on the output shaft 1603. The tensioning nut 161 is perpendicular to the guide plate. The tensioning nut 161 includes an internally threaded connecting portion (not shown) and a guide plate connecting portion 1610. The output shaft 1603 is provided with an externally threaded connecting portion 1604 engaging with the tensioning nut 161. The tensioning nut 161 performs its moving and locking functions by means of cooperation of the internally threaded connecting portion disposed therein and the externally threaded connecting portion 1604 on the output shaft 1603.

It may be appreciated that a screw rod may be unrotatably sleeved on the output shaft 1603. The screw rod can synchronously rotate along with rotation of the output shaft 1603. The tensioning nut 161 is sleeved around the screw rod and performs its moving and locking functions via cooperation between the internally threaded connecting portion disposed therein and the screw rod. The guide plate connecting portion 1610 is unitarily disposed on the internally-threaded connecting portion and fixedly connected with the guide plate 14. The guide plate 14 is provided with a guide plate mounting hole 140 cooperating with the guide plate connecting portion 1610. The guide plate connecting portion 1610 is received in the guide plate mounting hole 140 so that the guide plate 14 is brought into movement in a longitudinal direction by converting rotation of the output shaft 1603 into a linear movement of the tensioning nut 161, thereby achieving tensioning of the chain 10.

It may be appreciated that the transmission member also can employ a worm structure, the transmission member includes an input shaft, a worm gear, and an output shaft, wherein one end of the input shaft is connected with the tensioning handwheel and the other end thereof is unrotatably sleeved with the worm gear, and the output shaft is provided with a helical tooth structure cooperating with the worm gear and a threaded connecting portion cooperating with the tensioning nut. The guide plate is brought into reciprocating movement in a longitudinal direction by rotating the tensioning handwheel and thereby driving the output shaft to rotate, and by converting rotation movement of the output shaft into linear movement of the tensioning nut via cooperation between the output shaft and the tensioning nut.

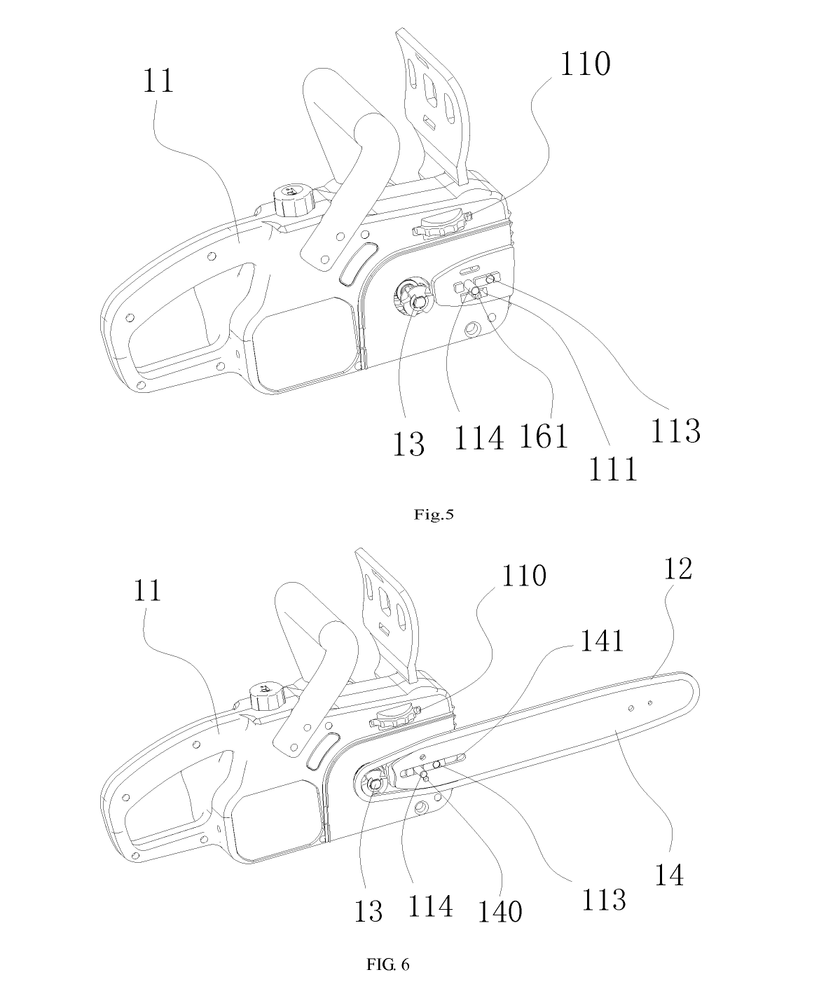

Referring to FIG. 5 and FIG. 6, the housing 11 is further provided with a guide portion 113, the guide plate 14 is provided with a guide hole 141 for receiving the guide portion 113, a width of the guide portion 113 is identical with that of the guide hole 141, and a length of the guide portion 113 is smaller than that of the guide hole 141. On one hand, the guide portion 113 functions to guide when the guide plate 14 moves in the longitudinal direction, and on the other hand, the guide portion 113 reinforces the guide plate 14 so as to reduce up-down shaking of the guide plate 14 in its plane when the chain saw 10 operates.

Then referring to FIG. 1 again, the chain saw 10 further includes a knob 150 disposed on the cover plate 15 and having internal threads, the cover plate 15 is located on one side of the housing 11 where the chain 12 is mounted, and is connected with the housing 11. The housing 11 is further provided with a bolt 114 for locking the cover plate 15, the bolt 114 passes through the guide hole 141 and engages with internal threads of the know 150. The cover plate 15 may be screwed tightly by rotating the knob 150. It may be appreciated that a screw rod may be provided on the knob 150, a threaded hole engaging the screw rod is provided on the housing 11, the cover plate 15 may be mounted on the housing 11 by screwing the knob 150 whereupon the cover plate 15 presses tightly upon the guide plate 14 to prevent it from shaking in a direction perpendicular to the guide plate 14.

The chain saw tensioning mechanism according to the illustrated embodiment is operated as follows: when an operator needs to tension the chain 12, the operator first loosens the knob 150 to loosen the cover plate 15, rotates the tensioning handwheel 162 in a tensioning direction of the guide plate 14, the tensioning handwheel 162 drives the input shaft 1600 and the first transmission element 1601 to rotate, the first transmission element 1601 drives the second transmission element 1602 to rotate, the second transmission element 1602 drives the output shaft 1603 to rotate, the output shaft 1603 drives the tensioning nut 161 screwed thereon to move in a direction tensioning the chain 12, the tensioning nut 161 brings the guide plate 14 to move away from the chain wheel 13 in a longitudinal direction thereof so that the chain 12 is tensioned on the guide plate 14 and the chain wheel 13, thereby performing a function of quickly tensioning the chain 12. On the contrary, when the operator needs to loosen the chain 12, the handwheel 162 is rotated in a direction loosening the chain 12, the guide plate 14 moves towards the chain wheel 13 under a series of transmissions reverse to the foregoing transmissions, the tensioned chain 12 is loosened so that the chain can be replaced and maintained conveniently and quickly.

Since the chain wheel tensioning mechanism 16 is wholly disposed in the housing 11, during assembly, first the guide plate 14 is positioned in the longitudinal direction by virtue of the mating between the guide hole 141 and the guide portion 113, then the guide plate 14 is movably mounted on the housing 11 by means of the mating between the guide plate mounting hole 140 and the guide plate connecting portion 1610 of the tensioning nut 161. Precise positioning is not required for the mating between the guide hole 141 and the guide portion 113, so actually the only need is to precisely position the locations of the guide plate mounting hole 140 and the guide plate connecting portion 1610. The assembly process is therefore convenient. Furthermore, on assembly, the positions of the tensioning nut 161 and the guide portion 113 may be observed so that the guide plate 14 is mounted more easily. Then the chain 12 is provided around a transmission supporting assembly formed by the chain wheel 13 and the guide plate 14, then the chain 12 is tensioned by turning the tensioning handwheel 162 by the above adjusting mode, finally the cover plate 15 is screwed tightly by means of the knob 150 on the cover plate 15 to prevent the guide plate 14 from shaking in a direction perpendicular to its plane. During the whole assembling procedure, positions and states of parts such as the chain 12, the guide plate 14, the tensioning nut 161 and the chain wheel 13 can be observed, the operation is accurate, tensioning is performed quickly, time is saved, and meanwhile a compact and beautiful shape is ensured.

Although the present invention is revealed as above by describing preferred embodiments, the embodiments are not used to limit the present invention. Those having ordinary skill in the art may make various alterations and modifications to the present invention without departing from the spirit and scope of the present invention. Hence, the scope of the present invention is defined by the appended claims.

What is claimed is:

1. A chain saw, comprising:
a housing;
a cutting chain;
a chain wheel driven by a motor, supported in the housing, and moving the cutting chain;
a guide plate for supporting and guiding the cutting chain wherein one end of the guide plate is supported on the housing with the other end thereof extends out of the housing in a longitudinal direction of the housing;
a cover plate cooperating with the housing to hold the guide plate to prevent the guide from shaking in a vertical direction; and
a chain wheel tensioning mechanism comprising a tensioning nut, a transmission member and, a tensioning handwheel, wherein the transmission member comprises an input shaft mounted on the housing and rotatable relative to the housing, a first transmission element driven by the input shaft, a second transmission element engaging the first transmission element, and an output shaft driven by the second transmission element, wherein the tensioning handwheel is coupled to the input shaft of the transmission member, wherein the tensioning handwheel at least partially extends out of the housing, wherein the tensioning nut is fixedly connected with the guide plate and threadedly connected with the output shaft of the transmission member to enable the guide plate to move relative to the output shaft, wherein the input shaft is disposed in a plane parallel to the guide plate, and wherein an angle between the input shaft and the output shaft of the transmission member is greater than 0° and less than 180°.

2. The chain saw according to claim 1, wherein both of the first transmission element and second transmission element are bevel gears and rotational axes of the first transmission element and the second transmission element are coplanar and parallel to the guide plate.

3. The chain saw according to claim 1, wherein the first transmission element is a worm gear and the second transmission element is a helical tooth structure formed on the output shaft.

4. The chain saw according to claim 1, wherein the input shaft and output shaft of the transmission member are perpendicular to each other.

5. The chain saw according to claim 4, wherein the output shaft is provided with an externally-threaded structure engaging with the tensioning nut and the tensioning nut performs its moving and locking functions by use of an engagement between an internally-threaded structure disposed therein and the externally-threaded structure on the output shaft.

6. The chain saw according to claim 4, wherein a screw rod is unrotatably sleeved around the output shaft, the screw rod synchronously rotates along with rotation of the output shaft, and the tensioning nut is sleeved around the screw rod and performs its moving and locking functions via engagement between an internally-threaded structure disposed therein and an externally-threaded structure on the screw rod.

7. The chain saw according to claim 1, wherein the housing has a mounting slot for receiving the output shaft and the output shaft is disposed in the mounting slot and rotatable about its own axis and the second transmission element is unrotatably connected on the output shaft.

8. The chain saw according to claim 1, wherein the tensioning nut is perpendicular to the guide plate, the tensioning nut includes an internally-threaded connecting portion connected with the output shaft and a guide plate connecting portion cooperating with the guide plate, the guide plate is provided with a guide plate mounting hole engaging with the guide plate connecting portion on the tensioning nut, and the guide plate connecting portion is received in the guide plate mounting hole so that the tensioning nut is able to cause the guide plate to move.

9. The chain saw according to claim 1, wherein the housing has a guide portion and the guide plate is provided with a guide hole, the guide portion is received in the guide hole, a width of the guide portion is identical with that of the guide hole, and a length of the guide portion is smaller than that of the guide hole.

10. The chain saw according to claim 9, wherein the housing is further provided with a bolt, and the chain saw further includes a knob disposed on the cover plate and having internal threads, the bolt passes through the guide hole and engage with the knob, and the cover plate is screwed on the guide plate by rotating the knob.
